(19) United States
(12) Patent Application Publication
(10) Pub. No.: US 2015/0336479 A1
(43) Pub. Date: Nov. 26, 2015

(54) MULTIFUNCTIONAL SEAT FOR AUTOMOBILE

(71) Applicant: UNISON WORLDWIDE LIMITED, Hong Kong (HK)

(72) Inventor: Shuk Ting Kam, Hong Kong (HK)

(21) Appl. No.: 14/325,385

(22) Filed: Jul. 8, 2014

(30) Foreign Application Priority Data
May 23, 2014 (CN) 201420266367.3

(51) Int. Cl. B60N 2/26; A01K 1/02

(52) U.S. Cl. CPC B60N 2/26; A01K 1/0272

(57) ABSTRACT

The present invention discloses a multifunctional seat for automobile comprising a base, a front wall extended from a front end of the base, a back wall extended from a back end of the base and side walls extended from side ends of the base, wherein a recessed space is formed and enclosed together by the base, the front wall, the back wall and the side walls; and the multifunctional seat for automobile further comprises a cushion arranged in the recessed space for sitting of an infant, and a filler detachably arranged on the cushion for reducing depth of the recessed space for ease of crouching of a pet. By providing the filler, the seat for automobile can be used for carrying the pet after the service life for the seat for infant usage is due, whereby improving the utilization rate of the seat for automobile.

### FIELD OF THE INVENTION

The present invention relates to a multifunctional seat for automobile, and in particular, to a seat used on a vehicle, such as an automobile, or the like.

### BACKGROUND

The increasing safety awareness makes people pay more and more attention to the security of the persons in the vehicle. Currently, an infant seat for automobile is widely used to improve the survival rate or reduce the injury severity of the infant in the automobile when a traffic accident occurs. In some European and North American countries, using the infant seat for automobile in the vehicle has become a mandatory legal provision. Therefore to some extent, the infant seat for automobile becomes a necessity for travel by automobile.

The service life of an infant seat for automobile is relatively short due to the fact that it is only for use with the infant, especially the infant between zero to three months old, and the use of a second-hand infant seat for automobile is impermissible for safety concerns. However, an ordinary infant seat for automobile has a high material cost due to the requirements of high strength and high performance. Therefore, an infant seat for automobile to be abandoned after several months of use is going to cause considerable waste of resources and serious damage to the environment.

### SUMMARY

A technical problem to be solved by the present invention is to provide a multifunctional seat for automobile which may prolong the service life and improving the utilization rate of the seat for automobile so as to decrease material waste and reduce environment damage.

To solve the above technical problem, embodiments of the present invention provide a multifunctional seat for automobile comprising a base, a front wall extended from a front end of the base, a back wall extended from a back end of the base and side walls extended from side ends of the base, wherein a recessed space is formed and enclosed together by the base, the front wall, the back wall and the side walls; and the multifunctional seat for automobile further comprises a cushion arranged in the recessed space for sitting of an infant; characterized in that it further comprises a filler detachably arranged on the cushion for reducing depth of the recessed space for ease of crouching of a pet.

In the multifunctional seat for automobile according to the present invention, the filler is a plate-like element for erecting on the cushion or the base, and forming a gap therebetween with the cushion or the base.

In the multifunctional seat for automobile according to the present invention, the filler is in a shape matched with that of bottom of the cushion or that of the base.

In the multifunctional seat for automobile according to the present invention, the filler is directly arranged on the cushion or the base.

According to the multifunctional seat for automobile of the present invention, the filler is connected to the cushion or the base in a roping manner, a screwing manner, an adhesive manner, or a sheathing manner.

According to the multifunctional seat for automobile of the present invention, a contact surface between the filler and the pet is flat.

The embodiments of the present invention have the advantages or beneficial effects as follows. By providing the detachable filler, the seat can be used by the infant normally when the filler is dismounted from the cushion. When the filler is arranged on the cushion, a platform for pet to crouch over is provided, thus providing security assurance for the pet in the automobile. Meanwhile, the filler also enables the pet owner to feel relieved during driving and not need to pay extra attention on the pet. The flat surface of the filler may ease pet's instinctive anxiety during the travel so as to prevent accident and risk from happening. Furthermore, the adoption of the detachable filler enables the traditional infant seat for automobile to provide a place for the pet to crouch over after the service life thereof, so that there is no need to abandon the original infant seat for automobile thereby avoiding waste.

### BRIEF DESCRIPTION OF THE DRAWINGS

To illustrate more clearly the technical solution of the embodiments of the present invention or the prior art, the drawings for use with the embodiments or the prior art are described briefly below. Apparently, the drawings referred to in the following description merely show some embodiments of the present invention, and a person skilled in the art may further derive other drawings from the attached drawings without any creative work.

FIG. 1 is a stereoscopic view of a multifunctional seat for automobile according to a preferred embodiment of the present invention;

FIG. 2 is a top view of the multifunctional seat for automobile in FIG. 1; and

FIG. 3 is a sectional view of the multifunctional seat for automobile taken along the line III-III in FIG. 2.

### DETAILED DESCRIPTION

The technical solutions of the embodiments of the present invention will be clearly and completely described below with reference to the accompanied drawings for the embodiments of the present invention.

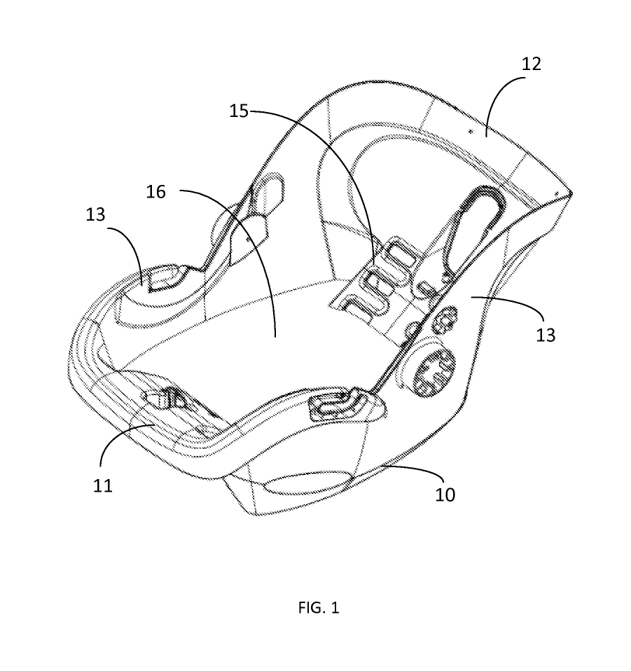

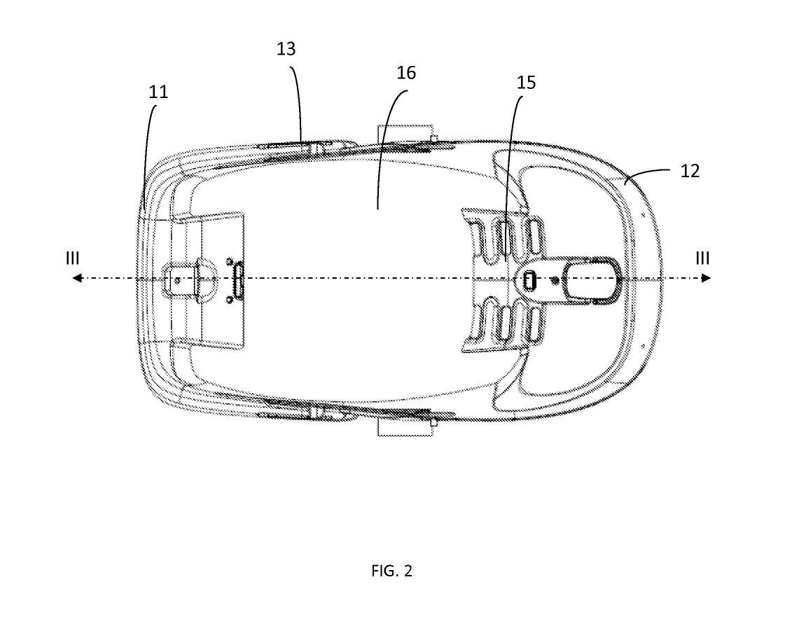

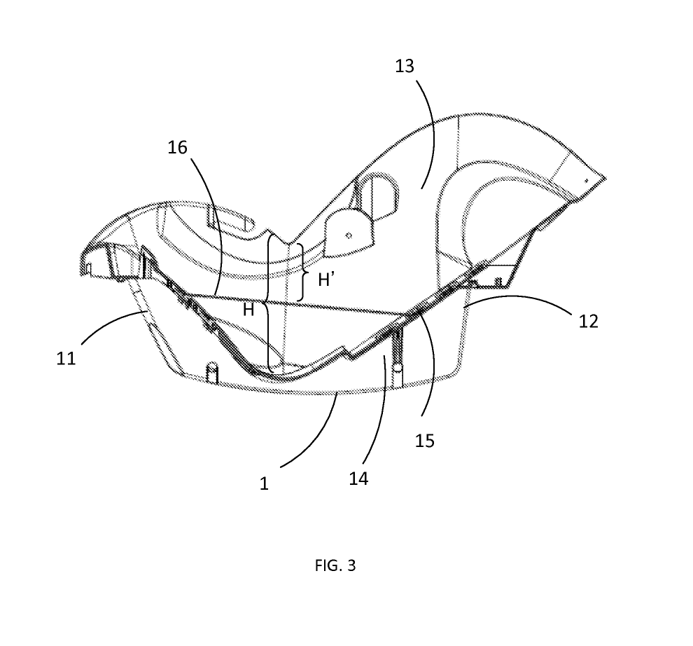

FIG. 1, FIG. 2 and FIG. 3 illustrate multifunctional seats for automobile according to preferred embodiments of the present invention. The seat for automobile may comprise a general structure of a traditional seat for automobile, such as a general fixing structure (for example, a LATCH system or an ISOFIX system), so that the multifunctional seat for automobile may be connected and fixed with conventional seats in the automobile.

In a particular embodiment, the multifunctional seat for automobile comprises a base 10, a front wall 11 extending from the front end of the base 10, a back wall 12 extending from the back end of the base 10 and side walls 13 extending from those two side ends of the base 10.

A recessed space 14 is formed and enclosed together by the base 10, the front wall 11, the back wall 12 and the side walls 13 wherein the back wall 12 is higher than the front wall 11 and the side wall 13, and the front wall 11 has a height substantially equal to the height of the side wall 13. In some embodiments, the height of the side wall 13 may increase gradually from one end connected with the front wall 11 to another end connected with the back wall 12.

The multifunctional seat for automobile further comprises a cushion 15. The lateral profile of the cushion 15 is substantially in an L shape. The cushion 15 is arranged in the recessed space 14 for a user to sit down. After the cushion 15 is arranged in the recessed space 14, the cushion, the front wall 11 and the back wall 12 are cooperatively forming an ergonomic shape, wherein the bottom of the cushion 15 is used for positioning of the buttocks of the user, the front part of the cushion 15 is fitted to the front wall 11 and used for positioning of the legs of the user, and the back part of the cushion 15 is fitted to the back wall 12 and used for positioning of the back of the user. The two side walls 13 are used for holding the body of the user to prevent the user from disengaging from the recessed space 14. The cushion 15 may be fixed and connected to the base 10, the front wall 11 and the back wall 12 by using conventional connection means.

As an improvement of the present invention, the multifunctional seat for automobile may further comprise a detachable filler 16 arranged on the cushion 15. In one embodiment, the filler 16 may be a plate-like element. As shown in FIG. 3, the filler 16 is set up on the cushion 15, such that a gap is formed between the filler 16 and the cushion 15.

In some embodiments, the filler 16 may further be directly fitted to the base, and set up on the base 10 to form a gap between the filler 16 and the bottom of the base 10.

In other embodiments, the filler 16 may further be an article matched with the shape of the bottom of the cushion 15 or the bottom of the base 10 so that the cushion 15 or the base 10 is substantially filled and leveled up and forming no recessed space therebetween, or the recessed space of the cushion 15 or the base 10 is reduced so as to considerably decrease the depth of the recessed space of the multifunctional seat for automobile when the filler 16 is arranged on the cushion 15 or the base 10. As shown in FIG. 3, the central depth of the multifunctional seat for automobile is H. When the filler 16 is arranged on the cushion 15, the central depth of the multifunctional seat for automobile is changed into H′, where H′ is smaller than H. In the embodiment as shown, H′ is approximately a half of H.

The filler 16 may be made of materials such as plastic, foam material, metal, wood, and the like. When the filler 16 is arranged on the cushion 15/base 10, the filler 16 may be connected to the cushion 15/base 10 in roping, screwing, adhesive, or sheathing manners, or the like. Moreover, the filler 16 may be directly arranged on the cushion 15/base 10 without fixation.

The filler 16 is used for the pet to crouch over. Therefore, the contact surface between the pet and the filler 16 may be either flat or slightly curved.

According to the multifunctional seat for automobile of the present invention, when the detachable filler 16 is dismounted from the cushion 15, the seat for automobile can be used by the infant normally. When the filler 16 is arranged on the cushion 15, a platform for pet to crouch is provided, thus providing security assurance for the pet in the automobile. Meanwhile, the detachable filler also enables the pet owner to feel relieved during driving and not need to pay extra attention on the pet. The flat surface of the filler 16 may ease pet's anxiety during the travel so as to prevent accident and risk from Happening. Furthermore, the adoption of the detachable filler 16 enables the traditional infant seat for automobile to provide a place for the pet to crouch over after the service life of the seat for automobile for the infant had been expired, so that there is no need to abandon the original infant seat for automobile, thus avoiding waste. Preferably, the filler 16 may be used on an infant seat for automobile so as to make the most of the materials and realize the technical effect of energy conservation and environment protection.

The foregoing embodiments are not intended to limit the protection scope of the technical solutions thereof, and any modification, equivalent substitution and improvement made without departing from the spirit and principle of the foregoing embodiments shall all fall within the protection scope of the technical solutions provided hereinbefore.

1. A multifunctional seat for automobile comprising a base, a front wall extended from a front end of the base, a back wall extended from a back end of the base and side walls extended from side ends of the base, wherein a recessed space is formed and enclosed together by the base, the front wall, the back wall and the side walls; and the multifunctional seat for automobile further comprises a cushion arranged in the recessed space for sitting of an infant; characterized in that it further comprises a filler detachably arranged on the cushion for reducing depth of the recessed space for ease of crouching of a pet.

2. The multifunctional seat for automobile according to claim 1, wherein the filler is a plate-like element for erecting on the cushion or the base, and forming a gap therebetween with the cushion or the base.

3. The multifunctional seat for automobile according to claim 1, wherein the filler is in a shape matched with that of bottom of the cushion or the base.

4. The multifunctional seat for automobile according to claim 1, wherein the filler is directly arranged on the cushion or the base.

5. The multifunctional seat for automobile according to claim 1, wherein the filler is connected to the cushion or the base in a roping, a screwing, an adhesive, or a sheathing manner.

6. The multifunctional seat for automobile according to claim 1, wherein a contact surface between the filler and the pet is flat.
